(19) United States
(12) Patent Application Publication
(10) Pub. No.: US 2015/0114769 A1
(43) Pub. Date: Apr. 30, 2015

(54) BRAKE APPARATUS FOR VEHICLE

(71) Applicant: HYUNDAI MOBIS CO., LTD., SEOUL (KR)

(72) Inventor: Jong Sung Kim, Yongin-si (KR)

(73) Assignee: HYUNDAI MOBIS CO., LTD., SEOUL (KR)

(21) Appl. No.: 14/253,676

(22) Filed: Apr. 15, 2014

(30) Foreign Application Priority Data
Oct. 25, 2013 (KR) 10-2013-0128124

(51) Int. Cl. F16D 65/00; F16D 65/14

(52) U.S. Cl. CPC F16D 65/0068; F16D 65/0006; F16D 65/14; F16D 2121/04
USPC 188/72.4

(57) ABSTRACT

A brake apparatus for a vehicle according to the present invention may comprise: a caliper body in which a hydraulic chamber is formed; a motor unit mounted in the caliper body; a gear unit coupled with the motor unit; a spindle unit coaxially coupled with the gear unit; a first piston which is movably mounted in the hydraulic chamber, receives a working fluid therein, and is associated with the brake pad; and a second piston movably coupled with the spindle unit for pressurizing the first piston by the working fluid as the second piston is moved toward inside the first piston.

### CROSS-REFERENCES TO RELATED APPLICATIONS

The present application claims priority to Korean application number 10-2013-0128124, filed on Oct. 25, 2013, which is incorporated by reference in its entirety.

### FIELD OF THE INVENTION

The present invention relates to a brake apparatus for a vehicle, and more particularly, to a brake apparatus for a vehicle in which the noise can be decreased and its size can be decreased.

### BACKGROUND OF THE INVENTION

In general, a vehicle is equipped with a brake apparatus for stopping a vehicle. Among a kind of the brake apparatus is an Electro-Mechanical Brake apparatus.

The Electro-Mechanical Brake apparatus comprises a motor, a plurality of gears and a screw transferring unit. If the motor is driven, the plurality of gears can be rotated in engagement with the motor. The screw transferring unit is coupled coaxially with an output shaft of the plurality of gears to convert a rotation movement of the motor into a translational movement of a screw. If the screw transferring unit is operated, a piston can be pressurized. As the piston pushes a brake pad, the brake pad becomes in friction with a brake disk. The screw transferring unit contacts the piston to support the piston so that the piston cannot be moved toward the opposite side from the brake pad.

Conventionally, as the screw transferring unit supports the piston directly, the noise therefrom can be increased. Furthermore, as the plurality of gears are installed to drive the screw transferring unit, the number of parts can be increased, thereby increasing its size. Therefore, the need for improving these problems exists in the art.

The background of the invention is disclosed in Korean Laid-open Patent publication No. 10-2012-0117405 published on Oct. 24, 2012, and entitled “Apparatus and method for controlling the brake force for a vehicle”.

### SUMMARY OF THE INVENTION

In view of the above, the present invention is proposed to improve the problems above, and thus the object of the present invention provides a brake apparatus for a vehicle in which the noise therefrom can be decreased and its size can be decreased.

In one embodiment, a brake apparatus for a vehicle according to the present invention may comprise: a caliper body in which a hydraulic chamber is formed; a motor unit mounted in the caliper body; a gear unit coupled with the motor unit; a spindle unit coaxially coupled with the gear unit; a first piston which is movably mounted in the hydraulic chamber, receives a working fluid therein, and is associated with brake pads; and a second piston movably coupled with the spindle unit for pressuring the first piston by the working fluid as the second piston is moved toward inside the first piston.

The caliper body may comprise a inlet port which is coupled with the hydraulic line and in fluid communication with the hydraulic chamber so that the working fluid can be supplied into the hydraulic chamber, and an exhaust port in fluid communication with the hydraulic chamber so that air in the hydraulic chamber can be exhausted while the working fluid is supplied into the hydraulic chamber.

The gear unit may comprise a first gear coaxially coupled with a shaft of the motor unit, and a second gear in mesh with the first gear, wherein the spindle unit is coaxially coupled with the second gear so as to be rotated by the second gear.

An O-ring may be installed between an outer surface of the first piston and a wall of the hydraulic chamber to prevent the leakage of the working fluid therebetween.

The second piston may be spaced from the first piston, and the second piston pressurizes the first piston by the working fluid mediated between the first piston and the second piston.

The brake apparatus for a vehicle may further comprise a coupling housing mounted in the caliper body for receiving the spindle unit and the second piston.

The spindle unit and the second piston may be threadedly engaged together, and the second piston may be not rotated together with, but is moved linearly inside the coupling housing, on rotation of the spindle unit.

A keyway may be formed on an inner surface of the coupling housing along a moving direction of the second piston, and a key may be formed on an outer surface of the second piston to move along the keyway thereby to prevent the second piston from rotating in a rotating direction of the spindle unit.

A sealing member may be disposed between the inner surface of the coupling housing and the outer surface of the second piston to prevent the leakage of the working fluid therebetween.

The keyway may be disposed more proximate to the gear unit than the sealing member.

The brake apparatus for a vehicle according to the present invention has the advantages that the noise therefrom can be decreased and its size can be decreased as the piston is supported by the fluid pressure.

The brake apparatus for a vehicle according to the present invention has the advantage that the friction area of the brake pads and a brake disk can be increased as the piston is supported by the fluid pressure.

### BRIEF DESCRIPTION OF THE DRAWINGS

FIG. 1 is a configuration view illustrating a fluid supplying structure of a brake apparatus for a vehicle according to an embodiment of the present invention.

FIG. 2 is a perspective view illustrating the brake apparatus for a vehicle according to an embodiment of the present invention.

FIG. 3 is a plan view illustrating the brake apparatus for a vehicle according to an embodiment of the present invention.

FIG. 4 is a cross-sectional view illustrating the brake apparatus for a vehicle according to an embodiment of the present invention.

FIG. 5 is a cross-sectional view illustrating an installation structure of a second piston of the brake apparatus for a vehicle according to an embodiment of the present invention.

FIG. 6 is a cross-sectional view illustrating the brake apparatus for a vehicle according to an embodiment of the present invention in which a first piston and the second piston are moved toward a brake disk.

### DESCRIPTION OF SPECIFIC EMBODIMENTS

Embodiments of the invention will hereinafter be described in detail with reference to the accompanying drawings. It should be noted that the drawings are not to precise scale and may be exaggerated in thickness of lines or sizes of components for descriptive convenience and clarity only.

Furthermore, the terms as used herein are defined by taking functions of the invention into account and can be changed according to the custom or intention of users or operators. Therefore, definition of the terms should be made according to the overall disclosures set forth herein.

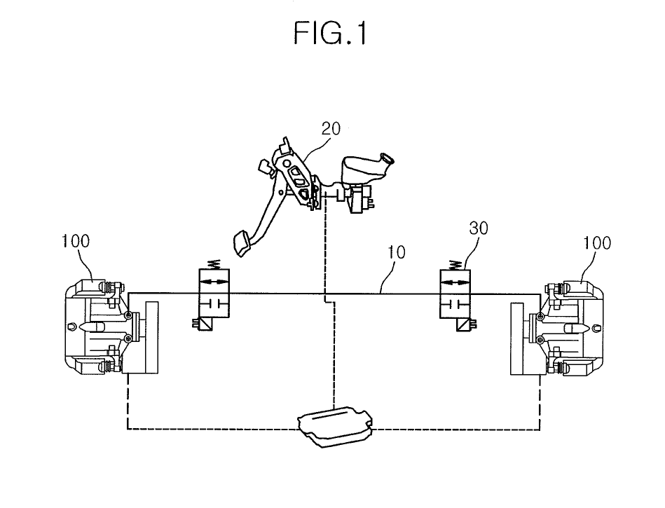

FIG. 1 is a configuration view illustrating a fluid supplying structure of a brake apparatus for a vehicle according to an embodiment of the present invention.

Referring to FIG. 1, the brake apparatus 100 for a vehicle according to an embodiment of the present invention is coupled with a hydraulic line 10 which in turn is coupled with a brake pedal 20. The hydraulic line 10 is equipped with a valve 30 to supply or block a working fluid. An electromagnetically opened or closed solenoid valve may be used as the valve 30.

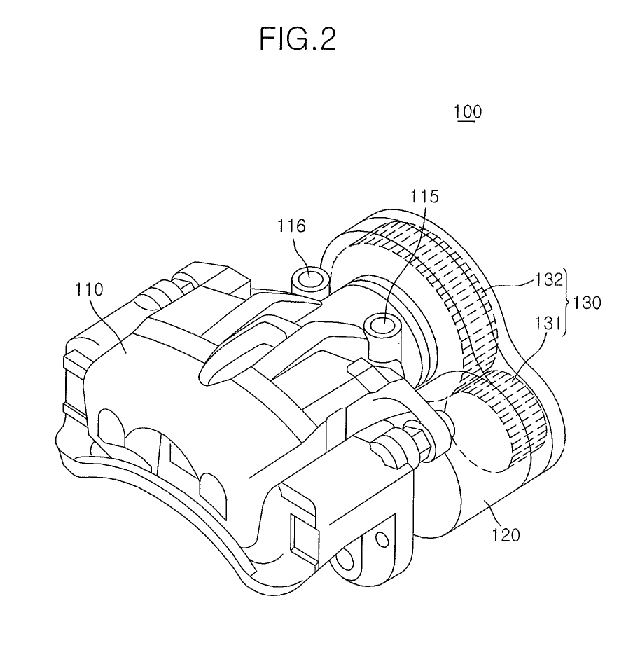

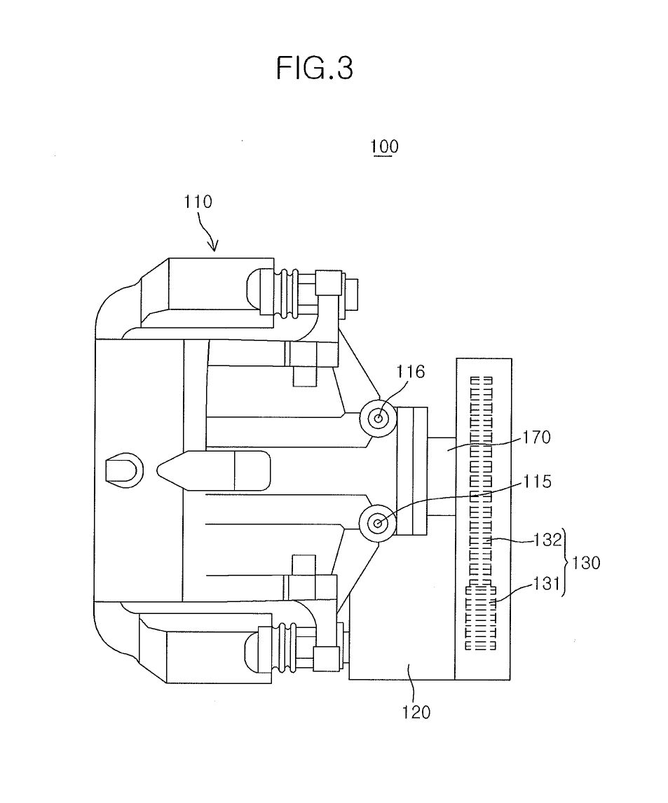

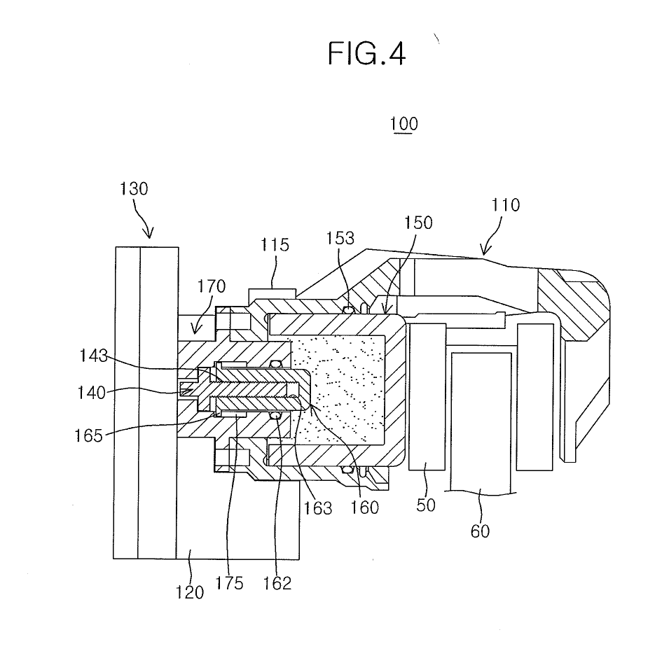

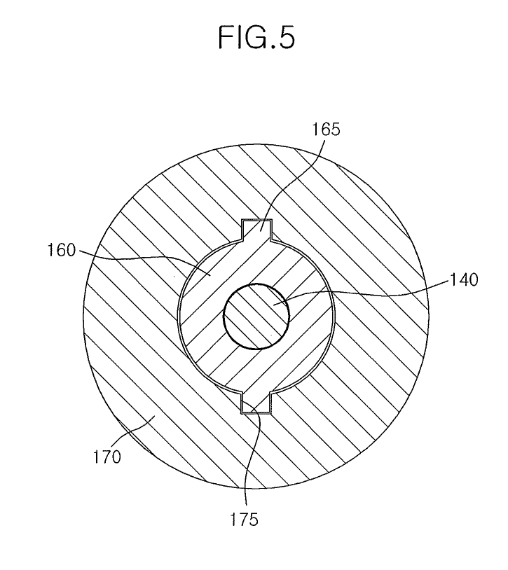

FIG. 2 is a perspective view illustrating the brake apparatus for a vehicle according to an embodiment of the present invention. FIG. 3 is a plan view illustrating the brake apparatus for a vehicle according to an embodiment of the present invention. FIG. 4 is a cross-sectional view illustrating the brake apparatus for a vehicle according to an embodiment of the present invention. FIG. 5 is a cross-sectional view illustrating an installation structure of a second piston of the brake apparatus for a vehicle according to an embodiment of the present invention.

Referring to FIGS. 2-5, the brake apparatus 100 for a vehicle may comprise a caliper body 110, a motor unit 120, a gear unit 130, a spindle unit 140, a first piston 150 and a second piston 160.

A hydraulic chamber (not shown) may be formed inside the caliper body 110. Brake pads 50 may be installed on either side of the hydraulic chamber. And, a brake disk 60 may be installed between the brake pads 50.

An inlet port 115 coupled with the hydraulic line 10 may be formed on the caliper body 110. The inlet port 115 may be in fluid communication with the hydraulic chamber so that the working fluid may be supplied to the hydraulic chamber. The working fluid may be non-compressible brake oil.

An exhaust port 116 in fluid communication with the hydraulic chamber may be formed on the caliper body 110 so that air in the hydraulic chamber can be exhausted. As the working fluid is supplied into the hydraulic chamber, air in the hydraulic chamber may be exhausted through the exhaust port 116.

The motor unit 120 may be mounted in the caliper body 110. The motor unit 120 may be disposed proximate to the hydraulic chamber. The motor unit 120 may be driven as a power supply is turned on.

The gear unit 130 may be coaxially coupled with the motor unit 120. The gear unit 130 may comprise a first gear 131 coaxially coupled with a shaft of the motor unit 120, and a second gear 132 in mesh with the first gear 131. Then, as the gear unit 130 can rotate the spindle unit 140 by the first gear 131 and the second gear 132, the number of gears 131, 132 for rotating the spindle unit 140 may be decreased. Thus, the size of the brake apparatus 100 for a vehicle will be decreased.

The spindle unit 140 may be coaxially coupled with the gear unit 130. The spindle unit 140 may be coaxially coupled with the second gear 132 to be rotated by the second gear 132. An outer surface of the spindle unit 140 may have threads 143. The spindle unit 140 may have a form in an approximately circular rod.

The first piston 150 may be movably mounted in the hydraulic chamber. The working fluid may be received toward inside the first piston 150. The first piston 150 may be associated with the brake pads 50. As the first piston 150 is moved toward one side, the brake pads 50 may brake the brake disk 60.

An O-ring 153 may be installed between an outer surface of the first piston 150 and a wall of the hydraulic chamber. The O-ring 153 prevents the working fluid from leaking between an outer surface of the first piston 150 and the wall of the hydraulic chamber.

The second piston 160 may be movably coupled with the spindle unit 140. If the second piston 160 is moved toward inside the first piston 150, the first piston 150 may be pressurized by the working fluid.

As the first piston 150 is pressurized by mediation of the working fluid, the first piston 150 may be pressurized in a state where the second piston 160 is spaced from the first piston 150. Accordingly, the noise that may be otherwise occurred due to friction between the first piston 150 and the second piston 160 may be avoided.

Furthermore, as the first piston 150 is pressurized by the pressure of the working fluid, the pressure of the working fluid may be applied uniformly on the first piston 150. Accordingly, as the first piston 150 pressurizes the brake pad 50 overall uniformly, a substantial friction area between the brake pad 50 and the brake disk 60 may be increased.

A cross-sectional area of the second piston 160 may be less than an inner cross-sectional area of the first piston 150. A distance that the first piston 150 is moved may be determined from the cross-sectional area and the moving distance of the second piston 160. For example, if a diameter of the second piston 160 is 30 mm and an inner diameter of the first piston 150 is 60 mm, the cross-sectional area of the first piston 150 may be four times the cross-sectional area of the second piston 160. Thus, if the second piston 160 is moved 4 mm, the first piston 150 may be moved about 1 mm. Like this, the moving distances of the first piston 150 and the second piston 160 may be determined, taking the cross-sectional area ratio of the first piston 150 to the second piston 160 into account.

The brake apparatus 100 for a vehicle may further comprise a coupling housing 170 mounted in the caliper body 110 for receiving the spindle unit 140 and the second piston 160. As the spindle unit 140 is coupled with the second piston 160 inside the coupling housing 170, the coupling housing 170 may be easily mounted in the caliper body 110. After the spindle unit 140 is coupled with the second piston 160, the spindle unit 140 and the second piston 160 may be assembled inside the coupling housing 170. Accordingly, before the coupling housing 170 is mounted in the caliper body 110, the length that the second piston 160 protrudes may be adjusted adequately.

A sealing member 162 may be disposed between an outer surface of the second piston 160 and an inner surface of the coupling housing 170. The sealing member 162 prevents the working fluid from leaking between the outer surface of the second piston 160 and the inner surface of the coupling housing 170.

An inner surface of the second piston 160 may have threads 163 to threadedly engage with threads 143 of the spindle unit 140. The second piston 160 may be moved linearly inside the coupling housing 170, and but may be installed not to rotate together with the spindle unit 140. Thus, as the spindle unit 140 is rotated, the second piston 160 may be moved linearly. It is noted that the structures that the second piston 160 cannot be rotated as the spindle unit 140 rotates may be formed in various forms. An example on this will be described below.

A keyway 175 may be formed on the inner surface of the coupling housing 170 along a moving direction of the second piston 160. The keyway 175 may be formed along a longitudinal direction of the second piston 160 and the spindle unit 140. A plurality of keyways 175 may be formed.

A key 165 may be formed on the outer surface of the second piston 160 to move along the keyway 175. The key 165 prevents the second piston 160 from rotating in a rotating direction of the spindle unit 140. That is, the key 165 confines the second piston 160 not to rotate in the rotating direction of the spindle unit 140.

As the spindle unit 140 and the second piston 160 are threadedly engaged together and the second piston 160 is not rotated in the rotating direction of the spindle unit 140, the second piston 160 may be moved in a linear path along the keyway 175, when the spindle unit 140 is rotated.

The keyway 175 may be disposed more proximate to the gear unit 130 than the sealing member 162. As the keyway 175 is disposed toward the gear unit 130 than the sealing member 162, the key 165 cannot contact the sealing member 162, although the second piston 160 is moved by the spindle unit 140. Therefore, the key 165 of the second piston 160 will not adversely affect the sealing function of the sealing member 162 and thus the structure of the sealing member 162 does not need the modification.

Now, the operations of the brake apparatus for a vehicle according to an embodiment the present invention configured as above will be described below.

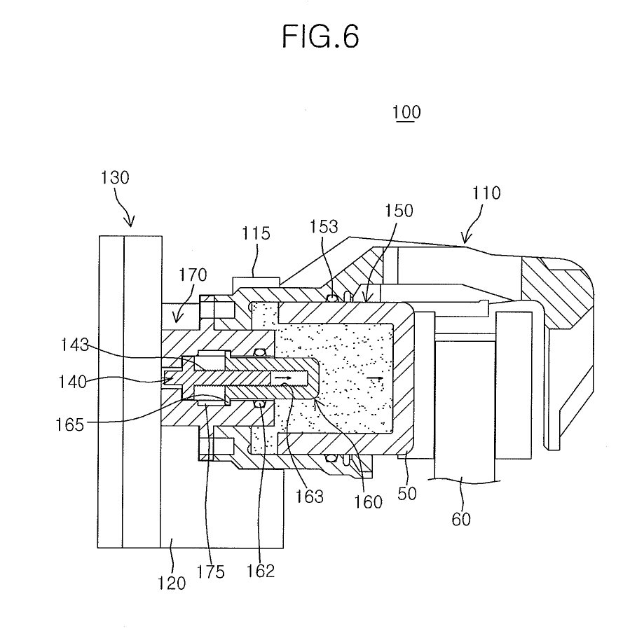

FIG. 6 is a cross-sectional view illustrating the brake apparatus for a vehicle according to an embodiment of the present invention in which the first piston and the second piston are moved toward a brake disk.

Referring to FIG. 6, if the brake pedal 20 is pushed, the valve 30 becomes open. And then, the working fluid is introduced into the hydraulic chamber of the caliper body 110 through the inlet port 115 of the caliper body 110. As the pressure of the hydraulic chamber is increased, the first piston 150 is moved toward the brake disk 60. If the brake pads 50 associated with the first piston 150 reaches the brake disk 60, the valve 30 becomes closed.

If the valve 30 is closed, supplying the working fluid into the hydraulic chamber becomes stopped. Here, as the first piston 150 is moved toward the brake disk 60 by the working fluid, the gap between the brake pads 50 and the brake disk 60 can be compensated, although the brake pads 50 may be worn.

And then, if the motor unit 120 is driven, the gear unit 130 becomes driven. And, as the first gear 131 and the second gear 132 are rotated engagedly together, the spindle unit 140 is also rotated.

On one hand, as the spindle unit 140 is threadedly engaged with the second piston 160 so that the key 165 of the second piston 160 can be inserted into the keyway 175 of the coupling housing 170, the second piston 160 will be moved linearly toward the first piston 150 on rotation of the spindle unit 140.

If the second piston 160 is moved, the non-compressible working fluid can pressurize the first piston 150. If the second piston 160 is moved a predetermined distance, the first piston 150 can be supported by the working fluid to prevent the first piston from withdrawing away from the brake disk 60.

Here, as the first piston 150 is pressurized by mediation of the working fluid, the first piston 150 can be pressurized in a state where the second piston 160 is spaced from the first piston 150. Accordingly, the noise that may be occurred due to friction between the first piston 150 and the second piston 160 can be avoided.

Furthermore, as the first piston 150 is pressurized by the pressure of the working fluid, the pressure of the working fluid may be applied uniformly on the first piston 150. Thus, as the first piston 150 pressurizes the brake pad 50 overall uniformly, the substantial friction area between the brake pad 50 and the brake disk 60 may be increased.

In addition, as the first piston 150 is coupled with the second piston 160 indirectly by mediation of the working fluid, the problems that the first piston 150 and the second piston 160 may be injured by the impact each other or worn by a contact each other may be avoided.

Moreover, as the second piston 160 pressurizes the spindle unit 140 by the reaction of the working fluid, the reaction of second piston 160 may be measured, if a pressure sensor can be installed between the spindle unit 140 and the gear unit 130. Thus, the cost may be decreased because a force sensor is not needed.

On the other hand, if the brake pedal 20 is released, the spindle unit 140 may be rotated to return to an original position. Also, if the valve 30 is opened, the pressure of the hydraulic chamber is decreased. And then, the first piston 150 may be moved into the original position.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A brake apparatus for a vehicle comprising:
a caliper body in which a hydraulic chamber is formed;
a motor unit mounted in the caliper body;
a gear unit coupled with the motor unit;
a spindle unit coaxially coupled with the gear unit;
a first piston which is movably mounted in the hydraulic chamber, receives a working fluid therein, and is associated with the brake pad; and
a second piston movably coupled with the spindle unit for pressurizing the first piston by the working fluid as the second piston is moved toward inside the first piston.

2. The brake apparatus for a vehicle of claim 1, wherein the caliper body comprises an inlet port which is coupled with the hydraulic line and in fluid communication with the hydraulic chamber so that the working fluid can be supplied into the hydraulic chamber; and an exhaust port in fluid communication with the hydraulic chamber so that air in the hydraulic chamber can be exhausted while the working fluid is supplied into the hydraulic chamber.

3. The brake apparatus for a vehicle of claim 1, wherein the gear unit comprises a first gear coaxially coupled with a shaft of the motor unit, and a second gear engaged with the first gear,
wherein the spindle unit is coaxially coupled with the second gear so as to be rotated by the second gear.

4. The brake apparatus for a vehicle of claim 1, wherein an O-ring is installed between an outer surface of the first piston and a wall of the hydraulic chamber to prevent the leakage of the working fluid therebetween.

5. The brake apparatus for a vehicle of claim 1, wherein the second piston is spaced from the first piston, and the second piston pressurizes the first piston by the working fluid mediated between the second piston and the first piston.

6. The brake apparatus for a vehicle of claim 1, further comprising a coupling housing mounted in the caliper body for receiving the second piston and the spindle unit.

7. The brake apparatus for a vehicle of claim 6, wherein the spindle unit and the second piston are threadedly engaged together,
the second piston is not rotated together with, but is moved linearly inside the coupling housing, on rotation of the spindle unit.

8. The brake apparatus for a vehicle of claim 7, wherein a keyway is formed on an inner surface of the coupling housing along a moving direction of the second piston,
a key is formed on an outer surface of the second piston to move along the keyway thereby to prevent the second piston from rotating in a rotating direction of the spindle unit.

9. The brake apparatus for a vehicle of claim 8, wherein a sealing member is disposed between the inner surface of the coupling housing and the outer surface of the second piston to prevent the leakage of the working fluid therebetween.

10. The brake apparatus for a vehicle of claim 9, wherein the keyway is disposed more proximate to the gear unit than the sealing member.
